(19) United States
(12) Patent Application Publication
(10) Pub. No.: US 2002/0167173 A1
(43) Pub. Date: Nov. 14, 2002

(54) Coupling system

(76) Inventors: John Griffin, Boca Raton, FL (US); Woodrow Dixon, Mercer, PA (US)

Correspondence Address: COZEN AND O'CONNOR, 1900 MARKET STREET, PHILADELPHIA, PA, 19103, US

(21) Appl. No.: 10/141,572

(22) Filed: May 7, 2002

Related U.S. Application Data
(60) Provisional application No. 60/289,433, filed on May 8, 2001.

(51) Int. Cl. F16L 15/00

(52) U.S. Cl. 285/404; 285/390

(57) ABSTRACT

An apparatus, system, and method of axially joining a first and second member having externally threaded ends without having to turn either member. The set of external threads of the first and second members are wound in a predetermined direction and are located on a first member end and a second member end respectively. In one aspect, the invention is three-piece apparatus comprising a coupling, a reverse, and an adapter.

### CROSS REFERENCE TO RELATED APPLICATIONS

Benefit of Provisional Application No. 60/289,433, filed May 8, 2001, is claimed.

### BACKGROUND OF THE INVENTION

This invention relates generally to couplings for connecting conduits and the like and, specifically, to a novel coupling system enabling the axial connection of like-threaded ends of two standard conduit members without requiring either conduit member to be turned during coupling or modified at the project site.

Although the present invention is described in relation to tubular electrical conduits used to house, shield and/or protect electrical power and data transmission wires, cables and the like, including fiber optic cables, it will be readily appreciated that the present invention may be useful in any application where it is desirable to axially couple or join two threaded ends of any types of members without turning the members to be joined. The present invention may be used to join conduit members, pipe members, solid bar, rod or shaft members, or any other members having threaded ends.

For purposes of this specification, “standard” or “right-hand” threads on the outside of a cylindrical member, exemplified by a screw or bolt, are threads which appear to traverse the outside cylindrical surface of the member upwardly from left to right if the longitudinal axis of the member is oriented vertically and the member is viewed from its side. Right-hand threads on the inside of a cylindrical bore in a second member, exemplified by a hexagonal nut, compatible in size with the above-described right-hand threaded cylindrical member, will engage with the threads on the cylindrical member such that turning the cylindrical member in a clockwise direction will draw the cylindrical member into the bore, e.g., turning the head of a right-hand threaded bolt clockwise with respect to a mating hexagonal nut will draw the bolt into the nut. Conversely, a bolt having “left-hand” threads will be drawn into a mating hexagonal nut by turning the head of the bolt in a counterclockwise direction. “Left-hand” threads are also known as “reverse” threads.

It is conventional in the manufacturing and supply of conduit system components for the manufacturer to make tubular conduits in various standard-length members, with the ends of each member having conventional right-hand external threads cut thereon for coupling members together using standard matching couplings. The standard coupling will comprise a sleeve-type coupling with an inside diameter and internal right-hand threads that are compatible with the external diameter and threads on the conduit member ends. When using typically manufactured conduit members with standard couplings at a job site, when a contractor needs to join two conduit members, the contractor first turns the standard coupling onto the externally threaded end of a conduit member. The contractor will then align a succeeding conduit member with the opposite end of the standard coupling that is engaged to the first conduit member and turn the succeeding conduit member into the standard coupling until the standard coupling and the conduit members are adequately engaged.

It also is conventional for manufacturers of conduit systems to make and supply a variety of standard “elbow” members, consisting of shorter lengths of conduit which have been bent at various radii to create an angled turn, for example a 90-degree turn. These elbow members typically also have standard right-hand outside threads on each end. Thus, in using a standard elbow member, the contractor can assemble a conduit line which makes a turn, as is required when a conduit line must turn a corner or change direction, for example, where a conduit must run from a ceiling (where it runs horizontally) into a wall (where it runs vertically). In order to assemble a standard elbow member onto a conduit line, the contractor must turn the preceding conduit member and/or turn the elbow member into a standard coupling.

It will be appreciated readily by persons who install such conduit systems that many situations arise where successful assembly of a conduit system by conventional means may be difficult or impossible using only the standard components described above. For example, where a contractor is required to install a conduit system in place, there may be insufficient space to allow an elbow member to be rotated and thereby turned into the coupling. Although space may permit turning a preceding straight conduit member into the coupling to join it to the elbow member, turning the preceding straight conduit member into the coupling with the succeeding elbow member simultaneously turns the conduit member out of the preceding coupling with its preceding conduit member.

Moreover, some applications present a situation where turning a conduit member is undesirable because turning the conduit member may twist the materials it is housing, thereby causing damage to the housed materials. In many applications, the contractor may be required to install a conduit already having electrical power or data transmission lines pulled therethrough. When the line housed in the conduit being installed is fragile, such as is a fiber optic cable, it may be impossible to turn lengths of conduit members to join them together without the risk of damaging the cable inside from twisting.

These problems have given rise to the use of prior art methods to join lengths of conduit without turning them. One method involves the use of reversing couplings and pipe-threading machinery and dies at the project site. A reversing coupling has standard right-hand threads inside one end and reverse, or left-hand, threads inside the other end. In order to use a reversing coupling, the contractor must sever the standard right-hand threaded end of the succeeding conduit member and then use the pipe threading machine and die to cut left-hand threads onto the newly cut end of the succeeding conduit member. The contractor may then join the ends of the preceding and succeeding conduit members by placing their oppositely threaded ends into the reversing coupling and turning only the coupling. The respective right-hand and left-hand threads on the ends of the preceding and succeeding conduit members, respectively, will mate with the right-hand and left-hand threads in the reversing coupling, and the conduit lengths will be drawn together. It can be readily appreciated that this method requires the use of extra equipment, i.e., the pipe threading machine and die, and a substantial amount of additional labor. This prior art method also increases the potential for mismeasured, wasted, underestimated or overestimated conduit material.

### SUMMARY OF THE INVENTION

These and other problems are solved by the present invention which in one aspect is an apparatus for axially joining a first member and a second member, the first member having a first member end having an external set of threads wound in a predetermined direction, the second member having a second member end having an external set of threads also wound in the predetermined direction. The apparatus comprises three components, a coupling, a reverser, and an adapter. The coupling comprises a first coupling end and a second coupling end, each of the first and second coupling ends having an internal set of threads wound in the predetermined direction, the first coupling end being adapted so that the set of internal threads of the first coupling end can mate with the set of external threads of the first member. The reverser comprises a first reverser end and a second reverser end, the first reverser end having a set of external threads wound in the predetermined direction and adapted to mate with the set of internal threads of the second coupling end, the second reverser end having a set of internal threads wound in a direction opposite to the predetermined direction. The adapter comprises a first adapter end and a second adapter end, the first adapter end having a set of external threads wound in the direction opposite to the predetermined direction and adapted to mate with the set of internal threads of the second reverser end, the second adapter end having a set of internal threads wound in the predetermined direction and adapted to mate with the set of external threads of the second member.

The apparatus can also comprise at least one set screw in the adapter, the coupling, or the reverser. Alternatively, the apparatus can have at least one set screw in each of the adapter, the coupling, and the reverser. By using set screws, relative motion of corresponding components is restricted when the components are assembled and the threads mated.

Preferably, either the adapter, the coupling, or the reverser will have a radial outside cross sectional profile that is square or hexagonal in shape. This allows a wrench or other gripping device to securely hold the components when assembling the apparatus. Also preferably, the predetermined direction is right-handed and the direction opposite the predetermined direction is left-handed. As such, it is preferable that the threads of the first member end, the second member end, the first coupling end, the second coupling end, the first reverser end, and the second adapter end be right-hand threads. Correspondingly, it is preferable that the threads of the second reverser end and the first adapter end be left-hand threads.

It is further preferable that the first and second members be tubular conduits having internal cavities. These internal cavities can be used for a variety of purposes, such as housing wires, cable, or other types of lines or carrying fluids. When the first and second members are tubular conduits having internal cavities, it is preferable that when the first member, the coupling, the reverser, the adapter, and the second member are threadily mated, a substantially unobstructed path is formed from the internal cavity of the first member to the internal cavity of the second member.

It also preferable that each of the set of threads of the first member, the adapter, the reverser, the coupling, and the second member circumscribe the first member, the adapter, the reverser, the coupling, and the second member a prescribed number of times. It is preferable that the prescribed number of times be five.

In another aspect, the invention is a system for axially connecting members comprising: a first member having a first member end having an external set of threads wound in a predetermined direction; a second member having a second member end having an external set of threads wound in the predetermined direction; a coupling comprising a first coupling end and a second coupling end, each of the first and second coupling ends having an internal set of threads wound in the predetermined direction, the first coupling end being adapted so that the set of internal threads of the first coupling end can mate with the set of external threads of the first member; a reverser having a first reverser end and a second reverser end, the first reverser end having a set of external threads wound in the predetermined direction and adapted to mate with the set of internal threads of the second coupling end, the second reverser end having a set of internal threads wound in a direction opposite to the predetermined direction; and an adapter having a first adapter end and a second adapter end, the first adapter end having a set of external threads wound in the direction opposite to the predetermined direction and adapted to mate with the set of internal threads of the second reverser end, the second adapter end having a set of internal threads wound in the predetermined direction and adapted to mate with the set of external threads of the second member.

It is preferable for this system to further comprise at least one set screw in the adapter, the coupling, or the reverser. Also preferably, either the adapter, the coupling, or the reverser of the system will have a radial outside cross sectional profile that is square or hexagonal in shape.

It is further preferable for the system that the predetermined direction be right-handed and the direction opposite the predetermined direction be left-handed. As such, it is preferable that the threads of the first member end, the second member end, the first coupling end, the second coupling end, the first reverser end, and the second adapter end be right-hand threads. Correspondingly, it is preferable that the threads of the second reverser end and the first adapter end be left-hand threads.

It is also preferable that the first and second members be tubular conduits having internal cavities. When the first and second members are tubular conduits having internal cavities, it is preferable that when the first member, the coupling, the reverser, the adapter, and the second member are threadily mated, a substantially unobstructed path is formed from the internal cavity of the first member to the internal cavity of the second member.

In yet another aspect, the invention is a method of axially connecting a first member and a second member comprising: providing the system described above; threadily engaging the set of external threads of the first member with the set of internal threads of the first coupling end by turning the coupling; threadily engaging the set of external threads of the second member with the set of internal threads of the second adapter end by turning the adapter; positioing the reverser between the second coupling end and the first adapter end so that the first member, the coupling, the reverser, the adapter, and the second member are axially aligned; and simultaneously threadily engaging the set of internal threads of the second coupling end with the set of external threads of the first reverser end and the set of internal threads of the second reverser end with the external set of threads of the first adapter end by turning the reverser.

Further aspects of the present invention will become apparent from the description provided below.

### BRIEF DESCRIPTION OF THE DRAWINGS

FIG. 1 is an axial cross section of the components of the system of the present invention shown assembled.

FIG. 2 is an axial cross section of a reverser.

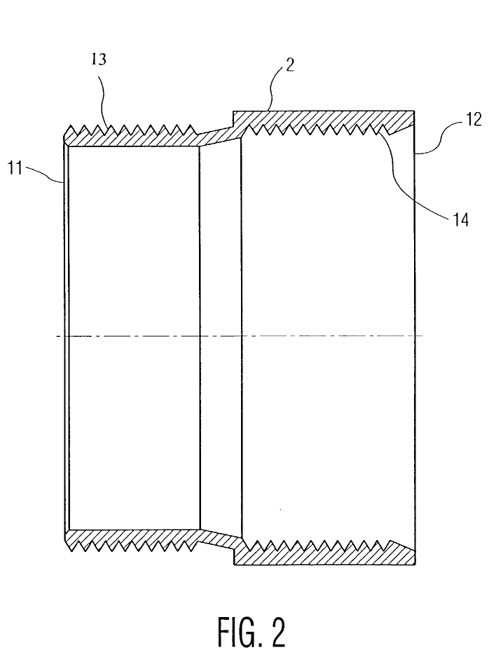

FIG. 3 is an axial cross section of an adapter.

FIG. 4 is a radial cross section taken along line IV-IV of FIG. 1, showing two set screws.

### DETAILED DESCRIPTION OF THE DRAWINGS

Although the present invention is described in the form of a coupling system for conduits, it is not so limited. It will be appreciated that the present invention may be used to join lengths of conduit, pipe, tube, bars, rods or shafts and the like, of any size, shape or material, in any application where it is desirable to join such members without turning them. It may be used for electrical conduits. It may be used in plumbing, to join pipe members. It may be used in mechanical applications, such as joining sections of drilling or drive shafts. Additionally, the components of the inventors' system may be made of any material, including but not limited to steel, other metals or plastic. The members to be joined may be of any material. The conduit, pipe, tube, bar, rod, shaft members or the like to be joined need not be of the same length, cross sectional shape or end diameter in order for the present invention to be applied.

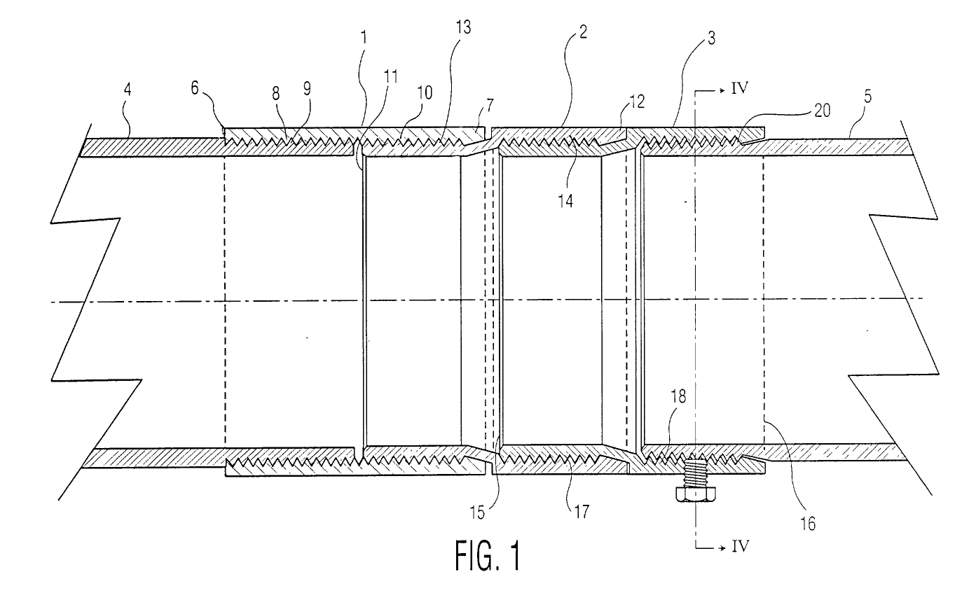

FIG. 1 illustrates the principal elements of one embodiment of the system of the invention, comprising coupling 1, reverser 2, adapter 3, first member, 4 and second member 5. In the illustrated embodiment, the first and second members 4, 5 are in the form of first and second cylindrical conduits 4 and 5, respectively. As illustrated, first and second cylindrical conduits 4 and 5 are tubular members having an internal cylindrical cavity. The internal cavities of conduits 4 and 5 can be used as housing for cables, wires, fiber-optic lines, etc., or the internal cavities can be used to transport fluids or gases.

Coupling 1 may be the standard type coupling such as would be typically supplied with standard conduit members 4 and 5 sought to be joined, or it may be a different, specialized coupling. The only requirement is that it meets the limitations described herein. Coupling 1 has first coupling end portion 6 and second coupling end portion 7. First coupling end 6 has a set of internal right-hand threads 8 which mate with set of external right-hand threads 9 located on the end of first conduit 4. This enables first coupling end 6 to be turned onto the end of first conduit 4 in a clockwise direction, threadily engaging and mating these components together. Second coupling end 7 may have the same inside dimensions, e.g. diameter and thread size, as first coupling end 6. Second coupling end 7 comprises set of internal right-hand threads 10. Set of internal threads 10 may be identical to and continuous with the internal threads 8 of first coupling end 6. However, it is possible for second coupling end 7 to have different dimensions, e.g. diameter and/or thread size, as first coupling end 6. As such, internal threads 10 of second coupling end 7 may be discontinuous with internal threads 8 of first coupling end 6.

Coupling 1 may be of any length or outside shape, provided that it has ends 6 and 7 with inside threads 8 and 10 as described herein. For example, coupling 1 may have a square or hexagonal outside radial cross sectional profile (such as a pipe union), to enable it to be turned or held stationary with a wrench. Coupling 1 also may take the form of a junction unit having third and possibly fourth ends (not shown) which enable the junction or union of more than two members.

Reverser 2 has first reverser end portion 11 and second reverser end portion 12. First reverser end 11 has an outside diameter and set of external outside right-hand threads 13 which are compatible with and capable of mating with the inside diameter and internal threads 10 of second coupling end 7, enabling first reverser end 11 to be turned into second coupling end 7 in a clockwise direction. Second reverser end 12 has an inside diameter and internal left-hand threads 14. There is no limitation on the outside shape or length of reverser 2, as long as it has sets of internal threads 11 and 12 as described herein. For example, the outside radial cross sectional profile of reverser 2 may be hexagonal or square in shape to enable it to be turned or held stationary with a wrench.

Adapter 3 has first adapter end portion 15 and second adapter end portion 16. First adapter end 15 has an outside diameter and external left-hand threads 17 which are compatible with the diameter and internal threads 14 of second reverser end 12, enabling first adapter end 15 to be turned into and mated with second reverser end 12 in a counterclockwise direction (looking into second reverser end 12). Second adapter end 16 has an inside diameter and a set of internal right-hand threads 18 which mate with the external right hand threads 20 of second conduit 5 sought to be joined, enabling second adapter end 16 to be turned into the end of second conduit 5 in a clockwise direction (looking into second adapter end 16). There is no limitation on the outside shape or length of adapter 3, as long as it has sets of threads 17 and 18 as described herein. For example, the outside radial cross sectional profile of adapter 3 may be hexagonal or square in shape to enable it to be turned or held stationary with a wrench.

Although, as set forth above, there is no limitation on the outside shapes of coupling 1, reverser 2, or adapter 3, in the illustrated embodiment of FIG. 1, the outsides of these components are cylindrical and their outside diameters are the same. With this arrangement, the assembled components provide a uniform cylindrical appearance which may be functionally or aesthetically desirable, for example, where the conduit system is to be in view after installation.

Additionally, there is no limitation on the thread sizes and dimensions of the various components' ends, as long as they mate and can thereby be turned together as described herein. Moreover, the various components may have inside and outside features which serve other functions. For example, the ends of coupling 1, reverser 2, and adapter 3 may be manufactured with inside and outside chamfers which perform a sealing function for plumbing applications. As with the outside shapes of the components, there are no limitations on the inside configurations or features of coupling 1, reverser 2, and adapter 3, as long as these components have threaded ends which are compatible and can be turned together as described herein.

Another feature which may be included is that each of the respective sets of threads 8, 10, 13, 14, 17 and 18 may circumscribe their respective ends 6, 7, 11, 12, 15 and 16 of the components at least a prescribed number of times. If this feature is included, and the components are turned together so that each of the prescribed number of threads is fully engaged, the coupling may satisfy specifications for explosion-preventive couplings. For example, for electrical conduit systems in certain applications where flammable gases or vapors are present, the National Electrical Code specifies that the coupling components be engaged with their mating components by a minimum number of five threads. Such a specification exists for the reason that it has been determined that during an explosion inside a conduit system, resulting from ignition of flammable vapors or gases which have entered the conduit system, gases will escape through any passages that exist, but the gases will be sufficiently cooled if they travel along a passage that is long in proportion to its width. Sufficient cooling prevents heat from escaping gases from igniting flammable vapors or gases outside the conduit system. It has been determined that the engagement of five threads creates an escape passage having the sufficient ratio of passage length to width. Thus, in such an example, the prescribed number of threads would be five.

Additionally, the ends of members sought to be joined may, for various reasons, come left-hand threaded instead of right-hand threaded as would be standard. Components analogous and therefore equivalent to those described herein may be used to join such members as described herein. The equivalent components would merely be mirror-images of those described herein, threaded in directions reverse to those described herein, and such equivalent components, therefore, are intended to be within the scope of the claims. Thus, the apparatus of the present invention (i.e. coupling 1, reverser 2, and adapter 3) can be used to join any join two members having external threads that are wound in the same direction, i.e. either both left-handed or both right-handed. As such, the direction of each set of threads of the apparatus is dictated by the predetermined direction in which the external threads 9 and 20 of conduits 4 and 5 are wound. For example, if the apparatus of the present invention is being used to join two members having left-hand external threads, the direction of each set of threads described above is reversed, i.e. left-hand threads would be right-hand threads and vice-versa.

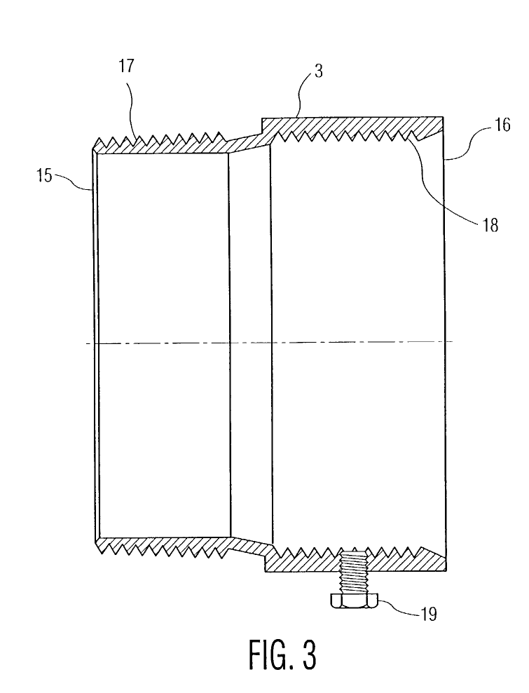

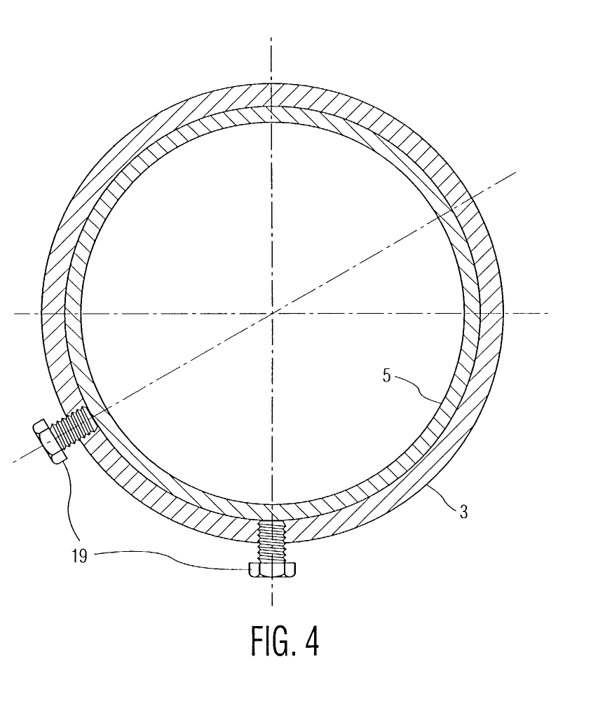

Referring to FIGS. 3 and 4, one or more set screws 19 may be included with adapter 3, reverser 2, or coupling 1 (adapter 3 is illustrated). Using set screws 19 will affix a component to the mating component onto which it has been turned. There is no limitation on the location of set screw 19 except that it must be located such that it will prevent relative rotation of mating components after being turned in.

In assembling the system illustrated in FIG. 1, the first and second conduits 4 and 5 may be joined without turning either conduit 4 or 5 by performing the method of the present invention. First coupling end 6 of coupling 1 is aligned with and turned onto the end of first conduit 4. Second adapter end 16 of adapter 3 is turned onto the end of second conduit 5. Optionally, set screws 19 may be inserted and turned to affix adapter 3 onto the end of first conduit 5. Thereafter, reverser 2 is positioned between coupling 1 and adapter 3, oriented as shown in FIG. 1. When coupling 1, reverser 2, and adapter 3 are brought together, joining may be accomplished by turning reverser 2 in a clockwise direction, relative to an axial view looking from second conduit 5 to first conduit 4. The ends of first and second conduits 4 and 5 are thereby drawn together and joined, by turning only reverser 2. In the preferred embodiment, this results in a substantially unobstructed path being formed between the internal cavities of conduits 4, 5.

It will be appreciated by those skilled in the art that the system of the present invention can enable the joining of respective conduit, pipe, rod, bar, shaft members and the like without the necessity of turning the members being joined. It will be further appreciated that the present invention eliminates the necessity of on-site cutting and threading of the ends of the members to be joined in order to accomplish such joining, and thereby eliminates the accompanying additional labor and material waste. It will be further appreciated that the system of the present invention is simple, easy to use and requires the manufacture and supply of only two parts which may be used in a wide variety of situations.

The foregoing discussion discloses and describes merely exemplary embodiments of the present invention. As will be understood by those skilled in this art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. An apparatus for axially joining a first member and a second member, the first member having a first member end having an external set of threads wound in a predetermined direction, the second member having a second member end having an external set of threads wound in the predetermined direction, the apparatus comprising:
a coupling comprising a first coupling end and a second coupling end, each of the first and second coupling ends having an internal set of threads wound in the predetermined direction, the first coupling end being adapted so that the set of internal threads of the first coupling end can mate with the set of external threads of the first member;
a reverser having a first reverser end and a second reverser end, the first reverser end having a set of external threads wound in the predetermined direction and adapted to mate with the set of internal threads of the second coupling end, the second reverser end having a set of internal threads wound in a direction opposite to the predetermined direction; and
an adapter having a first adapter end and a second adapter end, the first adapter end having a set of external threads wound in the direction opposite to the predetermined direction and adapted to mate with the set of internal threads of the second reverser end, the second adapter end having a set of internal threads wound in the predetermined direction and adapted to mate with the set of external threads of the second member.

2. The apparatus of claim 1 comprising at least one set screw in the adapter.

3. The apparatus of claim 1 comprising at least one set screw in the coupling.

4. The apparatus of claim 1 comprising at least one set screw in the reverser.

5. The apparatus of claim 1 comprising at least one set screw in each of the adapter, the coupling, and the reverser.

6. The apparatus of claim 1 wherein the adapter, the coupling, or the reverser has a radial outside cross sectional profile that is square or hexagonal in shape.

7. The apparatus of claim 1 wherein the predetermined direction is right-handed and the direction opposite the predetermined direction is left-handed.

8. The apparatus of claim 1 wherein the first and second members are tubular conduits having internal cavities.

9. The apparatus of claim 8 wherein when the first member, the coupling, the reverser, the adapter, and the second member are threadily mated, a substantially unobstructed path is formed from the internal cavity of the first member to the internal cavity of the second member.

10. The apparatus of claim 1 wherein each of the set of threads of the first member, the adapter, the reverser, the coupling, and the second member circumscribe the first member, the adapter, the reverser, the coupling, and the second member a prescribed number of times.

11. The apparatus of claim 10 wherein the prescribed number of times is five.

12. A system for axially connecting members comprising:
a first member having a first member end having an external set of threads wound in a predetermined direction;
a second member having a second member end having an external set of threads wound in the predetermined direction;
a coupling comprising a first coupling end and a second coupling end, each of the first and second coupling ends having an internal set of threads wound in the predetermined direction, the first coupling end being adapted so that the set of internal threads of the first coupling end can mate with the set of external threads of the first member;
a reverser having a first reverser end and a second reverser end, the first reverser end having a set of external threads wound in the predetermined direction and adapted to mate with the set of internal threads of the second coupling end, the second reverser end having a set of internal threads wound in a direction opposite to the predetermined direction; and
an adapter having a first adapter end and a second adapter end, the first adapter end having a set of external threads wound in the direction opposite to the predetermined direction and adapted to mate with the set of internal threads of the second reverser end, the second adapter end having a set of internal threads wound in the predetermined direction and adapted to mate with the set of external threads of the second member.

13. The system of claim 12 comprising at least one set screw in the adapter.

14. The system of claim 12 comprising at least one set screw in the coupling.

15. The system of claim 12 comprising at least one set screw in the reverser.

16. The system of claim 12 wherein the adapter, the coupling, or the reverser has a radial outside cross sectional profile that is square or hexagonal in shape.

17. The system of claim 12 wherein the predetermined direction is right-handed and the direction opposite the predetermined direction is left-hand.

18. The system of claim 12 wherein the first and second members are tubular conduits having internal cavities.

19. The system of claim 18 wherein when the first member, the coupling, the reverser, the adapter, and the second member are threadily mated, a substantially unobstructed path is formed from the internal cavity of the first member to the internal cavity of the second member.

20. A method of axially connecting a first member and a second member comprising:
providing the system of claim 12;
threadily engaging the set of external threads of the first member with the set of internal threads of the first coupling end by turning the coupling;
threadily engaging the set of external threads of the second member with the set of internal threads of the second adapter end by turning the adapter;
positioing the reverser between the second coupling end and the first adapter end so that the first member, the coupling, the reverser, the adapter, and the second member are axially aligned; and
simultaneously threadily engaging the set of internal threads of the second coupling end with the set of external threads of the first reverser end and the set of internal threads of the second reverser end with the external set of threads of the first adapter end by turning the reverser.
